(19) United States
(12) Patent Application Publication
(10) Pub. No.: US 2004/0177526 A1
(43) Pub. Date: Sep. 16, 2004

(54) Custom protector for table or tablecloth

(75) Inventor: Andrew Shevins, Woodmere, NY (US)

Correspondence Address: JAMES & FRANKLIN, LLP, Suite 2915, 60 60 East 42nd Street, New York, NY, 10165, US

(73) Assignee: BARRY LEONARD, President and CEO

(21) Appl. No.: 10/384,852

(22) Filed: Mar. 11, 2003

(51) Int. Cl. B43L 7/00

(52) U.S. Cl. 33/566

(57) ABSTRACT

A sheet of transparent or opaque soft vinyl or plastic is customized for use as a table or tablecloth protector by selecting one of a variety of different size color-coded paper patterns and using the pattern as a template, to cut the protective sheet to the size of the table or tablecloth to be protected. The protective sheet may be flannel backed and/or may have a quilted surface.

The present invention relates to a protector for a table or a tablecloth and more particularly, to a protector that is capable of being customized by the user to accurately fit a table or a tablecloth of a variety of different sizes in an inexpensive and efficient manner.

Pads made of rigid material, often with a felt layer on one side surface, are well known in the art. Such pads are factory fabricated to a specific set of dimensions in accordance with measurements provided to the factory. The pads are designed to be situated on the table to protect the finish of the surface of a table against scratches and dents from hard objects and from discoloration due to liquid spills.

However, such pads tend to be thick, heavy and bulky, and thus hard to handle. Although they may be made in sections that fold, rigid pads are difficult to store and take up a lot of room. Further, they must be stored flat to avoid warping.

Since the pads must be fabricated to the exact dimensions of the table, careful measurements of the table must be taken and provided to the factory. If the shape of the tabletop is not a standard shape such as rectangular, square or round, a professionally made template may be necessary to insure proper fit.

Because several pads are generally required for each table, the cost of a set of such pads can be quite high. It would not be unusual for a set of pads to cost several hundred dollars.

A less expensive alternative to a set of rigid table pads is a sheet of flexible plastic or vinyl material with a felt or other backing to make it thick enough to provide protection for the surface of the table. Because the sheet can be rolled easily, the storage problems inherent with rigid pads are eliminated. However, since the flexible sheet must still accurately fit the table, it is necessary for the supplier to fabricate and the retailer to inventory protective sheets in many different standard sizes and shapes to accommodate a wide variety of table sizes and shapes. Protective sheets for odd sized or shaped tables may not be available at all or may be available only by special order.

Flexible plastic or vinyl sheets are also sold for use over tablecloths as protectors for the tablecloths themselves. These protective sheets are often made of thin transparent materials so the decorative aspects of the tablecloth are not obscured. However, such flexible tablecloth protectors suffer some of the same disadvantages as flexible table protectors in that many different standard size and shapes are required and tablecloth protectors for use on odd size or shaped tables may not be available at all or only on special order.

My invention overcomes these problems by providing an inexpensive, flexible protector that can be easily customized by the purchaser to a selected one of a variety of different sizes using one of a plurality of color coded paper patterns as a template. Depending upon the characteristics of the sheet material, my invention can be used to protect the surface of a table or a tablecloth. My protector is light weight and easy to store.

It is, therefore, a prime object of the present invention to provide a system for customizing a protector for a table or a tablecloth.

It is another object of the present invention to provide a system for customizing a protector for a table or tablecloth that fits a variety of different sizes and shapes.

It is another object of the present invention to provide a system for customizing a protector for a table or tablecloth that is inexpensive, light weight and easy to store.

In accordance with one aspect of the present invention, apparatus is provided for customizing a protector for a table or tablecloth for a selected one of a variety of different sizes. The apparatus includes a sheet of protective material at least as large as the largest size required. A plurality of different patterns are provided. Each of the patterns corresponds to a different one of the smaller sizes. The user can select the pattern corresponding to the required smaller size. The selected pattern is placed over the sheet. The pattern issued as a template to cut the sheet to the size of the selected pattern.

The protective material may be plastic, such as soft vinyl, or it may be made of fabric. It may include a flannel backing and may be quilted.

Preferably, the patterns are made of paper. Each of the patterns may be a different color. Each of the colors may correspond to a different one of the smaller sizes.

In accordance with another aspect of the present invention, a method is provided for customizing a protector for a table or a tablecloth for a selected one of a variety of different sizes. The method includes providing a sheet of protective material at least as large as the largest required size. A plurality of different patterns are provided. Each pattern corresponds to a different one of the smaller sizes. The pattern corresponding to the required smaller size is selected. The selected pattern is placed over the sheet. The pattern is used as a template to cut the sheet to the size of the selected pattern.

The material may be made of plastic, such as soft vinyl may be made of fabric. It may have a flannel backing. It may be quilted.

The pattern is preferably made of paper. Each of the patterns may be provided with a different color. Each of the colors may correspond to a different one of the smaller sizes.

If the table or tablecloth has a non-standard size or shape, the pattern with the next largest size is selected. That pattern is trimmed to the required size or shape before use as a template.

To these and to such other objects which may hereinafter appear, the present invention relates to a custom protector for a table or a tablecloth, as described in detail in the following specification, recited in the annexed claims and illustrated in the accompanying drawings, in which like numerals refer to like parts and wherein:

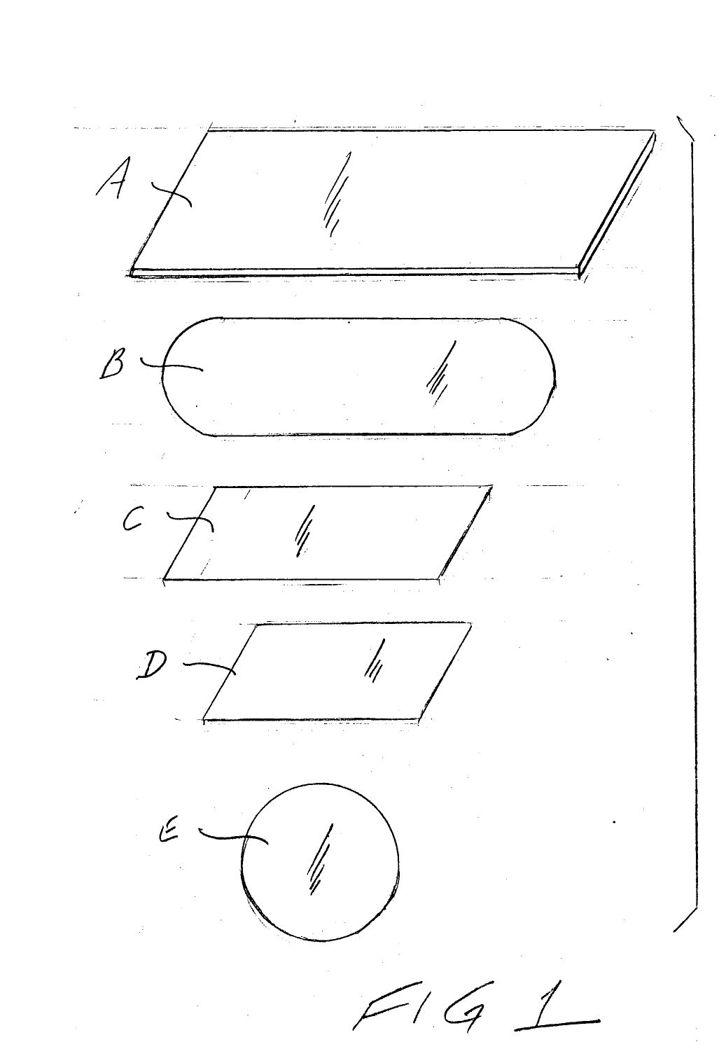

FIG. 1 is an exploded isometric view showing the custom kit including a protective sheet and a plurality of different size patterns.

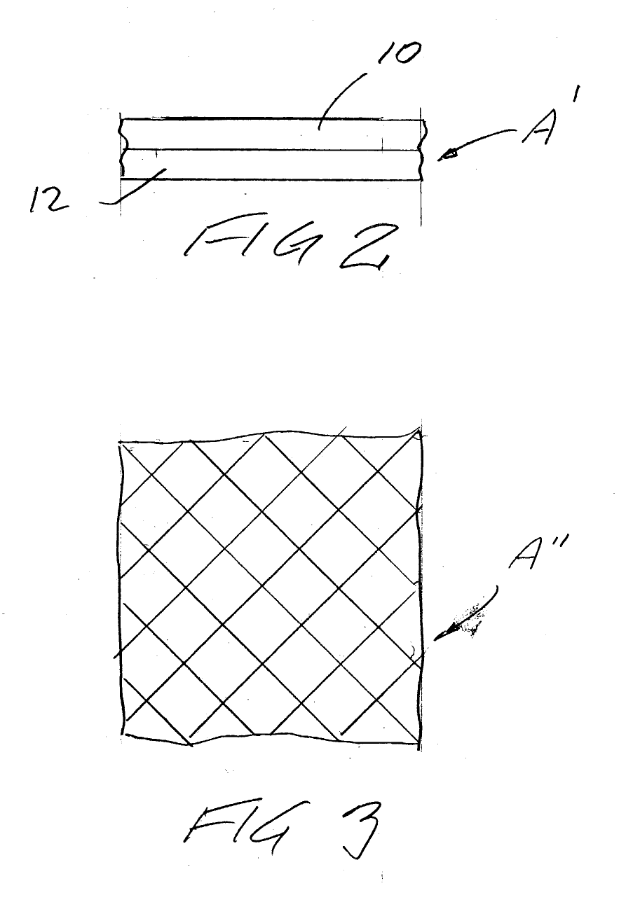

FIG. 2 is a cross-sectional view of a flannel backed protector, and

FIG. 3 is a plan view of a section of a quilted protector.

As illustrated in FIG. 1, the consumer is supplied with a kit or package including a flexible sheet of protective material, generally designated A, and several patterns, generally designated B, C, D and E, respectively. The illustrated kit can be used to provide a protector of five different sizes. In this specification, the term “size” is used to indicate dimensions as well as shape. Thus, a 72Δ×108″ rectangle is considered a different size than a 72″×108″ oval and a 72″×72″ square is considered to be a different size than a 72″ diameter round.

Material A can be a sheet of any flexible, durable material, such as transparent, translucent or opaque plastic, vinyl or fabric. It can vary in thickness and have a smooth or non-smooth surface finish. It can be flannel backed, as shown in FIG. 2 or quilted, as shown in FIG. 3. The light transmissiveness, thickness and composition of sheet A depends upon the intended application. Tablecloth protectors tend to be clear, soft vinyl and thin. Table protectors are often opaque and formed of thicker fabric that is flannel backed and/or quilted.

Preferably, sheet A would be sized to fit the largest size table or tablecloth for which the kit is intended, for example, to accommodate a 72″×108″ rectangular table or a tablecloth for that size table. For that size, no cutting of sheet A is required.

The patterns correspond to the smaller size tables or tablecloths for which the protector could be used and are preferably made of a paper product. Each is preferably a different color so that the different patterns can be readily distinguished. For example, pattern B might correspond to a 60″×90″ oval table or a tablecloth for that size table and be red. Pattern C might correspond to a 50″×80″ rectangular table or a tablecloth suitable for that size table and be yellow. Pattern D might correspond to a 40″×60″ rectangular table or for a tablecloth suitable for that size table and be green. Pattern E might correspond to a 40″ round table or for a tablecloth suitable for that size table and be blue. Obviously, as many different patterns can be provided with each protector sheet as desired.

The user selects the appropriate pattern by placing each in turn on the surface of the table, or on the tablecloth to be protected, to see which fits best. If none fit exactly, the next largest pattern is selected and trimmed with a scissor to the exact size and shape.

The selected pattern is then placed adjacent sheet A and used as a template to guide the user as the sheet is cut by a scissors to the size of the pattern. The result is a protector accurately sized to custom fit the user's table as a protector for the table surface or tablecloth protector, depending upon the properties of the material used.

FIG. 2 shows a cross section of a dual layer protective sheet A′ which includes a vinyl or fabric top layer 10 and a flannel backing layer 12. FIG. 3 shows a sheet protective A″ which has a quilted surface layer. Both embodiments would be suitable for use as a table protector.

When not in use, sheet A is simply rolled up and stored in any closet. There is no need to store the protector flat, as warping is not a problem.

It will now be appreciated that the present invention relates to a custom protector for a table or a tablecloth that is easily cut to the required size using the color coded paper patterns provided. The properties of the protective sheet are selected depending upon the intended use as a protector for a table surface or a tablecloth protector. The protector is light weight, easily stored and inexpensive.

While only a limited number of preferred embodiments of the present invention have been disclosed for purposes of illustration, it is obvious that many variations and modifications could be made thereto. It is intended to cover these variations and modifications that fall within the scope of the invention, as defined by the following claims:

I claim:

1. Apparatus for customizing a protector for a table or a tablecloth for a selected one of a variety of different sizes, comprising a sheet of protective material at least as large as the largest required size and a plurality of different size patterns, each of said patterns corresponding to a different smaller size, such that the user can select the pattern corresponding to the required smaller size, place the selected pattern adjacent the sheet and use the pattern as a template to cut the sheet to the size of the selected pattern.

2. The apparatus of claim 1 wherein said material comprises soft vinyl.

3. The apparatus of claim 1 wherein said material comprises a flannel backing.

4. The apparatus of claim 1 wherein said material is quilted.

5. The apparatus of claim 1 wherein said material comprises fabric.

6. The apparatus of claim 1 wherein said patterns are paper.

7. The apparatus of claim 1 wherein each of said patterns is a different color and each of said colors corresponds to a different one of the smaller required sizes.

8. A method for customizing a protector for a table or tablecloth for a selected one of a variety of different sizes, the method comprising the following steps:
(a) providing a sheet of protective material at least as large as the largest required size;
(b) providing a plurality of different size patterns, each pattern corresponding to a different smaller size;
(c) selecting the pattern corresponding to the required smaller size;
(d) placing the selected pattern adjacent the sheet; and
(e) using the pattern as a template to cut the sheet to the size of the selected pattern.

9. The method of claim 8 wherein said material comprises soft vinyl.

10. The method of claim 8 wherein said material comprises a flannel backing.

11. The method of claim 8 wherein said material is quilted.

12. The method of claim 8 wherein said material comprises fabric.

13. The method of claim 8 wherein said pattern is paper.

14. The method of claim 8 further comprising the step of providing each of the patterns with a different color, each of the colors corresponding to a different one of the smaller sizes.

15. The method of claim 8 further comprising the step of trimming the selected pattern prior to placing it adjacent the sheet.
